(19) United States
(12) Patent Application Publication
(10) Pub. No.: US 2009/0219478 A1
(43) Pub. Date: Sep. 3, 2009

(54) DISPLAY DEVICE AND METHOD OF MANUFACTURING THE DISPLAY DEVICE

(75) Inventors: Hong-Jo PARK, Suwon-si (KR); Hyeok-Jin LEE, Seongnam-si (KR); Sung-Jae YUN, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/187,709

(22) Filed: Aug. 7, 2008

(30) Foreign Application Priority Data
Feb. 28, 2008 (KR) 10-2008-0018199

(51) Int. Cl. G02F 1/1339; G02F 1/1333

(52) U.S. Cl. 349/155; 349/187

(57) ABSTRACT

A display device includes a first substrate having first and second electrodes spaced apart from each other, a protrusion pattern portion disposed underneath at least one of the first and second electrodes, and a spacer portion on the same layer as the protrusion pattern portion and made of the same material as the protrusion pattern portion, a second substrate that faces the first substrate and includes a column spacer facing the spacer portion, and a liquid crystal layer disposed between the first and second substrates. The spacer portion and the column spacer function to maintain a gap between the first and second substrates. The liquid crystal layer is in an isotropic state when no electric field is applied and is in an anisotropic state when an electric field is applied.

### CROSS-REFERENCE TO RELATED APPLICATION

This application claims priority from and the benefit of Korean Patent Application No. 10-2008-0018199, filed on Feb. 28, 2008, which is hereby incorporated by reference for all purposes as if fully set forth herein.

### BACKGROUND OF THE INVENTION

1. Field of the Invention

The present disclosure relates to a display device.

2. Discussion of the Background

There are many different types of display devices. Particularly, liquid crystal displays (LCDs), which may be thin and lightweight and have improved performance due to developments in semiconductor technology, have been widely used as the display devices.

Light transmittance of the LCDs is determined by an alignment state of liquid crystal molecules. Since the light transmittance is controlled by physical movement of the liquid crystal molecules, the response speed of an LCD may be low.

Recently, a blue-phase liquid crystal having a relatively fast response speed of about 3 μm/s has been developed. The blue-phase liquid crystal may have a very narrow operational temperature range. Therefore, a monomer may be added to the blue-phase liquid crystal to stabilize the crystal structure of the blue-phase liquid crystal.

When no electric field is applied to the blue-phase liquid crystal, the blue-phase liquid crystal changes to a blue-phase state having an optical isotropic property, but not having a double refractive property. When the electric field is applied to the blue-phase liquid crystal, the blue-phase liquid crystal has an optical anisotropic property and a double refractive property. At this point, the electric field is substantially applied in a horizontal direction. The horizontal direction indicates a direction that is parallel to a pair of substrates that face each other with the blue-phase liquid crystal interposed therebetween. The electric field is applied to the blue-phase liquid crystal through electrodes disposed on the substrates.

However, the LCD using the blue-phase liquid crystal may have limitations that increase driving voltage and deteriorate light transmittance.

Therefore, the electrodes may protrude in a direction crossing the substrates to enhance a horizontal electric field applied to the blue-phase liquid and lower the driving voltage.

Although the driving voltage may be gradually reduced as the degree to which the electrodes protrude increases, a cell gap should be increased to secure sufficient light transmittance. The cell gap is a gap between the substrates, which face each other with the blue-phase liquid crystal disposed therebetween. That is, since a region where the electric field is induced exists above the electrodes, the region where the electric field is formed may be gradually reduced as the degree to which the electrodes protrude increases. Therefore, the cell gap should be increased as the degree to which the electrodes protrude increases. If the region where the electric field is formed is not sufficiently secured, the light transmittance may deteriorate.

### SUMMARY OF THE INVENTION

The present invention discloses a display device that may have a reduced driving voltage can be reduced and improved light transmittance.

The present invention also discloses a method of manufacturing the display device.

Additional features of the invention will be set forth in the description which follows, and in part will be apparent from the description, or may be learned by practice of the invention.

The present invention discloses a display device including a first substrate having first and second electrodes spaced apart from each other, a protrusion pattern portion disposed underneath at least one of the first and second electrodes, and a spacer portion on the same layer as the protrusion pattern portion and made of the same material as the protrusion pattern portion, a second substrate that faces the first substrate and includes a column spacer facing the spacer portion, and a liquid crystal layer disposed between the first and second substrates. The spacer portion and the column spacer function to maintain a gap between the first and second substrates. The liquid crystal layer is in an isotropic state when no electric field is applied, and is in an anisotropic state when an electric field is applied.

The present invention also discloses a method of manufacturing a display device including forming at least one thin film transistor on a substrate member, forming a photosensitive organic layer on the substrate member and the thin film transistor, exposing and developing the photosensitive organic layer to form a protrusion pattern and a spacer pattern, and disposing a column spacer facing the spacer portion, wherein the thin film transistor is located between the substrate member and the spacer portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of a display device according to an exemplary embodiment of the present disclosure.

FIG. 2 is a cross-sectional view taken along line II-II of FIG. 1.

FIG. 3 shows a process for stabilizing a blue-phase liquid crystal used in the display device of FIG. 1.

FIG. 4 shows a variation of a blue-phase liquid crystal used for the display device of FIG. 1 depending on whether an electric field is applied or not.

FIG. 5 is a graph showing a relationship between a height of a protrusion pattern portion, a driving voltage, and an effective cell gap.

FIG. 6, FIG. 7, FIG. 8, FIG. 9, FIG. 10, and FIG. 11 are cross-sectional views showing a method of manufacturing the display device of FIG. 1 according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

In the accompanying drawings, a display device using amorphous silicon thin film transistors (a-Si TFTs) that are formed through a process using 5 masks is schematically shown. In addition, two TFTs are used for one pixel in the accompanying drawings. The pixel is a minimum unit to display an image. The TFT may be modified in various ways.

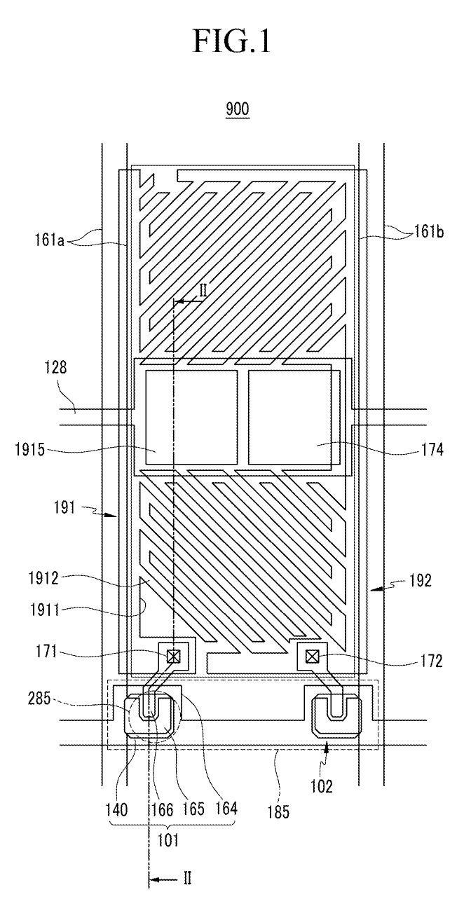

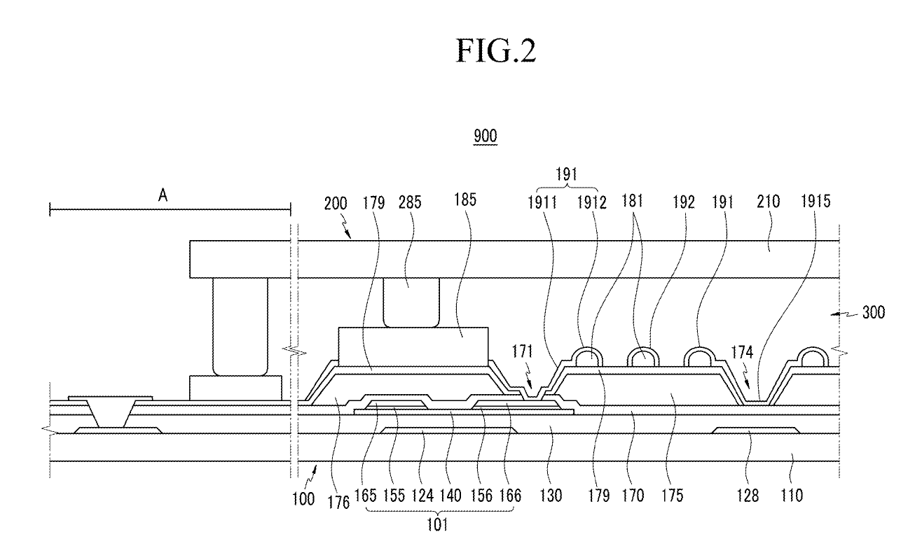

An exemplary embodiment of the present disclosure will now be described with reference to FIG. 1 and FIG. 2. FIG. 1 and FIG. 2 show a display device of an exemplary embodiment of the present disclosure. In FIG. 2, a right portion of area A is a cross-sectional view taken along line II-II of FIG. 1 and area A is a cross-sectional view of an edge of the display device of FIG. 1.

As shown in FIG. 1 and FIG. 2, a display device 900 includes a first substrate 100, a second substrate 200, and a liquid crystal layer 300.

The first substrate 100 includes a first substrate member 110, a first electrode 191, a second electrode 192, a protrusion pattern portion 181, and a spacer portion 185.

The first and second electrodes 191 and 192 are disposed on the first substrate member 110 and are spaced apart from each other. The first and second electrodes 191 and 192 may have slit patterns that are alternately engaged with each other.

The protrusion pattern portion 181 is disposed underneath at least one of the first and second electrodes 191 and 192. In FIG. 2, the protrusion pattern portion 181 is disposed underneath both the first and second electrodes 191 and 192. The present disclosure, however, is not limited to this configuration. That is, the protrusion pattern portion 181 may be disposed underneath only one of the first and second electrodes 191 and 192.

Since the protrusion pattern portion 181 is disposed underneath the first and second electrodes 191 and 192, a horizontal electric field may be effectively induced between the first and second electrodes 191 and 192. The horizontal electric field indicates an electric field that is applied in a horizontal direction that is substantially parallel with the first and second substrates 100 and 200 that face each other with the liquid crystal layer 300 disposed therebetween. That is, since the first and second electrodes 191 and 192 protrude due to the protrusion pattern portion 181 disposed underneath thereof, a horizontal electric field may be effectively induced between the first and second electrodes 191 and 192. Each of the first and second electrodes 191 and 192 may have a width of 1-10 μm. The first and second electrodes 191 and 192 may be spaced apart from each other by a distance of 3-6 μm. As the distance between the first and second electrodes 191 and 192 is reduced, the performance of the display device may be improved. However, in an actual manufacturing process, the distance between the first and second electrodes 191 and 192 may be limited within a range of 3-6 μm in consideration of a process margin.

When the distance between the first and second electrodes 191 and 192 is greater than the width of each of the first and second electrodes 191 and 192, it may be advantageous in reducing the light transmittance. When the distance between the first and second electrodes 191 and 192 is less than the width of each of the first and second electrodes 191 and 192, it may be advantageous in reducing the driving voltage. The display device 900 using the blue-phase liquid crystal may have a relatively high driving voltage and thus it may be advantageous to reduce the driving voltage. Therefore, the width of each of the first and second electrodes 191 and 192 may be greater than or equal to the distance between the first and second electrodes 191 and 192. The present invention, however, is not limited thereto. When it is intended to enhance the light transmittance rather than to reduce the driving voltage, each of the first and second electrodes 191 and 192 may be designed to have a width that is less than the distance between the first and second electrodes 191 and 192.

Each protrusion of the protrusion pattern portion 181 may have a width of 1-10 μm, and the protrusions may be spaced apart from each other by a distance of 3-6 μm. When the protrusion pattern portion 181 is disposed underneath only one of the first and second electrodes 191 and 192, the distance between the protrusions of the protrusion pattern portion 181 may be outside the range of 3-6 μm.

In FIG. 2, the protrusion pattern portion 181 has a semi-circular section or a semi-oval section. The present invention, however, is not limited to this. Therefore, the protrusion pattern portion 181 may be designed to have a polygonal section.

The first substrate 100 further includes TFTs 101 and 102, gate lines 121, and data lines 161a and 161b, all of which are disposed on the first substrate member 110.

The TFTs 101 and 102 will be included to first and second TFTs, respectively. The first TFT 101 is connected to the first electrode 191 and the second TFT 102 is connected to the second electrode 192. The first and second TFTs 101 and 102 are connected to the common gate line 121. The first and second TFTs 101 and 102 are further connected to the data lines 161a and 161b, respectively. Therefore, different voltages are applied to the first and second electrodes 191 and 192 and thus the horizontal electric field is generated between the first and second electrodes 191 and 192. The horizontal electric field indicates an electric field that is induced in a direction that is substantially parallel with the substrates 100 and 200. The liquid crystal molecules of the liquid crystal layer 300 move according to the horizontal electric field induced between the first and second electrodes 191 and 192.

The spacer portion 185 corresponds to the first and second TFTs 101 and 102. That is, the first and second TFTs 101 and 102 are disposed between the first substrate member 110 and the spacer portion 185. The spacer portion 185 planarizes a region above the first and second TFTs 101 and 102.

The protrusion pattern portion 181 and the spacer portion 185 may be made of an organic material. In more detail, the protrusion pattern portion 181 and the spacer portion 185 may be formed by exposing and developing a photosensitive organic layer.

In addition, the first substrate 100 further includes a color filter 175. The color filter 175 is disposed between the first substrate member 110 and the protrusion pattern portion 181. The color filter 175 functions to provide color to light passing through the liquid crystal layer.

The second substrate 200 includes a second substrate member 210 and a column spacer 285 disposed on the second substrate member 210. The column spacer 285 is disposed to face the spacer portion 185 of the first substrate 100. The column spacer 285 and the spacer portion 185 stably maintain a gap between the first and second substrates 100 and 200.

The liquid crystal layer 300 includes cross-linked blue-phase liquid crystal. As described above, the liquid crystal layer 300 is disposed between the first and second substrates 100 and 200. The blue-phase liquid crystal molecules of the liquid crystal layer 300 move according to the horizontal electric field generated between the first and second electrodes 191 and 192. Since the blue-phase liquid crystal has a relatively narrow operational temperature range, a non-liquid crystal monomer may be added to a low molecular weight liquid crystal that can change to a blue-phase state. Ultraviolet rays are irradiated to the monomer to polymerize the monomer. As a result, a cross-linked blue-phase liquid crystal with a stabilized crystal structure is formed. The cross-linked blue-phase liquid crystal has a network polymer formed in the low molecular weight liquid crystal. That is, the blue-phase liquid crystal is stabilized to have a wide operational range by being polymerized when a monomer added to chiral nematic liquid crystal is hardened. The blue phase is a liquid crystal phase that appears at a temperature range between a cholesteric phase and an isotropic phase.

When the liquid crystal layer 300 includes the blue-phase liquid crystal, alignment layers between the first and second substrates 100 and 200 may be omitted. When no electric field is applied to the blue-phase liquid crystal, the blue-phase liquid crystal changes to a blue-phase state with optical isotropic property, but not a double refractive property. When the electric field is applied to the blue-phase liquid crystal, the blue-phase liquid crystal may have both an optical anisotropic property and a double refractive property. As the intensity of the electric field increases, the number of directors aligned in an electric field direction may increase, thereby changing an input polarization state. That is, the blue-phase liquid crystal molecules of the liquid crystal layer 300 may control light transmittance while their alignments change according to the horizontal electric field formed between the first and second electrodes 191 and 192.

Since the blue-phase liquid crystal may have the optical isotropic property when no electric field is applied, the display device 900 may have a normally black mode. That is, when no voltage is applied to the electrodes 191 and 192, the display device 900 may display black.

An acrylate-based monomer, which may be polymerized by heat or ultraviolet rays, may be used as the non-liquid crystal monomer. However, the present invention is not limited thereto. For example, materials including a polarization group such as a vinyl group, an acryloyl group, a fumarate group, and the like may be used as the non-liquid crystal monomer. Meanwhile, an initiator, which may initiate the polymerization of the cross-linking agent, and a monomer may be used as needed. Acetophenone, benzophenone, or the like may be used as the initiator. Chiral dopants may be added to the liquid crystal layer 300 to change the liquid crystal to a chiral nematic phase.

A material that can change to the blue-phase state between the chiral phase and the isotropic phase may be used as the low molecular weight liquid crystal. The low molecular weight liquid crystal may include a molecular structure of a biphenyl, a cyclohexyl, or the like. The low molecular weight liquid crystal may have chirality itself or may be made of a material that can change to a cholesteric phase when chiral dopants are added thereto.

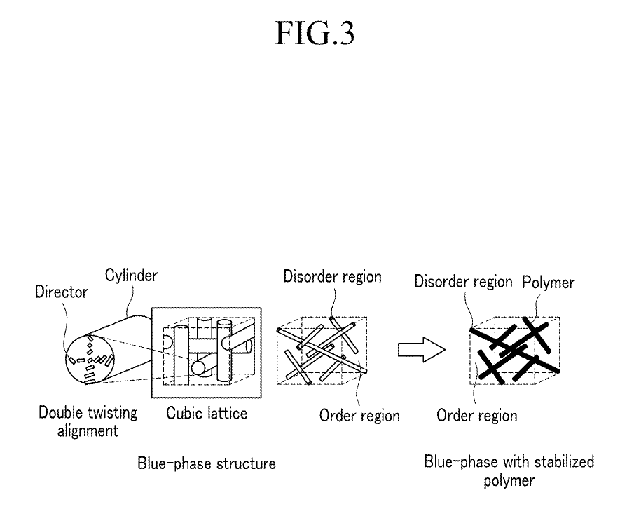

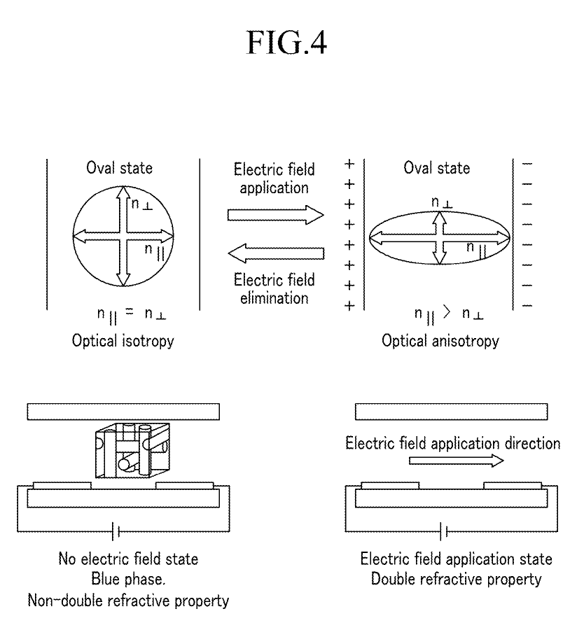

The following will describe the blue-phase liquid crystal used in the display device 900 of FIG. 1 and FIG. 2 in more detail with reference to FIG. 3 and FIG. 4.

As shown in FIG. 3, the blue-phase liquid crystal is made by stabilizing the blue-phase state up to a room temperature region by forming a photo-linkable polymer when a chiral phase is induced to a positive liquid crystal and the blue phase is formed at about 1 K (absolute temperature).

The blue-phase liquid crystal that is stabilized at a wider temperature range by the polymer may have a very large equilibrium constant (K). Therefore, when the electric field is applied to the blue-phase liquid crystal, gray levels can be represented. In addition, when no electric field is applied, the blue-phase liquid crystal has an optical isotropic property.

As shown in FIG. 4, when no electric field is applied to the blue-phase liquid crystal, the blue-phase liquid crystal changes to the blue-phase state having the optical isotropic property, but not the double refractive property. When the electric field is applied to the blue-phase liquid crystal, the blue-phase liquid crystal has both an optical anisotropic property and a double refractive property. At this point, the electric field is applied to the blue-phase liquid crystal in a direction crossing with a direction in which the light passes through the liquid crystal layer 300.

The blue-phase liquid crystal used in the display device 900 may have a chiral pitch of 300 nm or less because the chiral pitch of the blue-phase liquid crystal should be different from a wavelength of visible light. For example, the blue-phase liquid crystal may have a chiral pitch of 200 nm. For example, since the wavelength of the visible light may be about 350-650 nm, the blue-phase liquid crystal used in the display device 900 may have chiral pitch of 300 nm or less.

The blue-phase liquid crystal may have a very high dielectric constant and a very high refractive index. In addition, the blue-phase liquid crystal may be nematic liquid crystal.

The protrusion pattern portion 181 may have a height of 1-6 μm. When the height of the protrusion pattern portion is less than 1 μm, the intensity of the horizontal electric field is reduced, which may prevent reduction of the driving voltage. When the height of the protrusion pattern portion is greater than 6 μm, the driving voltage reduction effect may be improved but a minimum gap between the first and second substrates 100 and 200, which is required to secure sufficient light transmittance, is significantly increased. That is, as the height of the protrusion pattern 181 increases, a space that is defined above the first and second electrodes 191 and 192 and where the electric field is induced is gradually reduced. When the space where the electric field is formed is not sufficiently secured, the light transmittance may deteriorate.

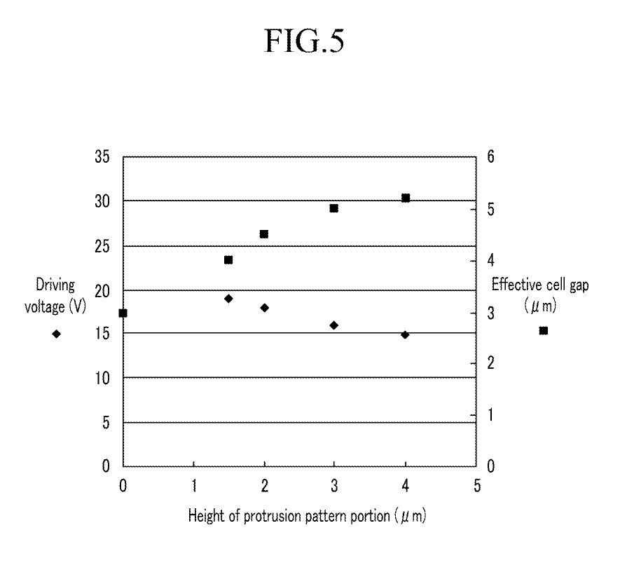

FIG. 5 shows variations of a driving voltage and an effective cell gap depending on the height of the protrusion pattern portion. An effective cell gap indicates a minimum gap between the first and second substrates 100 and 200 that can secure proper light transmittance. Referring to FIG. 5, as the height of the protrusion pattern portion 181 increases, the driving voltage of the display device 900 may be reduced while the effective cell gap is increased.

A height of the spacer portion 185 may be greater than the height of the protrusion pattern portion 181. That is, the spacer portion 185 is higher than the protrusion pattern portion 181. In more detail, the height of the spacer portion 185 may be within a range of 1.1-10 μm.

A minimum gap that is defined between the first and second substrates 100 and 200 by the spacer portion 185 of the first substrate 100 and the column spacer 285 of the second substrate 200 may be 3 μm or more. The minimum gap between the first and second substrates 100 and 200 may be greater than the height of the protrusion pattern portion 181. That is, the minimum gap between the first and second substrates 100 and 200 may be set in consideration of a process margin in addition to the effective cell gap determined in accordance with the height of the protrusion pattern portion 181.

Therefore, a relatively large gap may be required between the first and second substrates 100 and 200 depending on the height of the protrusion pattern portion 181.

For example, when the protrusion pattern portion 181 is designed to have a height of about 3 μm to effectively reduce the driving voltage, an effective cell gap of about 5 μm or more may be required. At this point, considering the process margin, a minimum cell gap of about 7 μm or more may be required between the first and second substrates 100 and 200.

That is, the display device 900 using the blue-phase liquid crystal may require a relatively large gap between the substrates 100 and 200.

When the gap between the first and second substrates 100 and 200 is maintained by only the column spacer 285 of the second substrate 200 without using the spacer portion 185 of the first substrate 100, a bottom area of the column spacer 285 should be increased in proportion to the height of the column spacer 285. Therefore, an area occupied by the column spacer 285 may significantly increase as the cell gap increases. In this case, an aperture ratio of the display device 900 may be reduced and thus image quality of the display device 900 may deteriorate.

However, according to the exemplary embodiment of the present disclosure, the relatively large gap may be stably maintained between the first and second substrates 100 and 200 by forming the spacer portion 185 on the first substrate member 110 and by forming the column spacer 285 on the second substrate member 210 corresponding to the spacer portion 185.

Since the spacer portion 185 on the first substrate 100 may be formed during a process for forming the protrusion pattern portion 181, the number of processes may not be increased. That is, the spacer portion 185 may be simultaneously formed with the protrusion pattern portion 181 and may include the same material as the protrusion pattern portion 181.

The following will describe the display device 900 in more detail with reference to FIG. 2. FIG. 2 shows a portion around the first TFT 101. In the following description, only the first TFT 101 is described, but it should be noted that the second TFT 102 may have an identical structure to that of the first TFT 101.

A structure of the first substrate 100 will first be described.

The first substrate member 110 may includes a transparent material, such as glass, quartz, ceramic, or plastic.

A plurality of gate metal lines including a plurality of gate lines 121, a plurality of gate electrodes 124 branched from the gate lines 121, and a plurality of storage electrode lines 128 are disposed on the first substrate 110.

The gate metal lines 121, 124, and 128 may include a metal such as Al, Ag, Cr, Ti, Ta, Mo, and Cu, or an alloy containing at least one of these metals. In FIG. 2, each gate metal line 121, 124, and 128 may be a single metal layer. However, the present invention is not limited thereto. For example, each gate metal line 121, 124, and 128 may include multiple layers having a first metal layer including a metal such as Cr, Mo, Ti, and Ta, which has excellent physicochemical properties, or an alloy containing at least one of these metals, and a second metal layer including a Al-based metal or Ag-based metal having low resistivity. In addition to the above metals, various other metals or conductive materials may be used to form the gate metal lines 121, 124, and 128. In addition, the gate metal lines 121, 124, and 128 may include multiple layers that can be patterned under the same etching conditions.

A gate dielectric 130, which may include silicon nitride (SiNₓ), is disposed on the first substrate member 110 to cover the gate metal lines 121, 124, and 128.

The data metal lines including a plurality of data lines 161a and 161b crossing the gate lines 121, a plurality of source electrodes 165 branched from the data lines 161a and 161b, and a plurality of drain electrodes 166 spaced apart from the source electrodes 165 are disposed on the gate dielectric 130.

Like the gate metal lines 121, 124, and 128, the data metal lines 161a, 161b, 165, and 166 may include a metal such as Cr, Mo, Al, and Cu, or an alloy containing at least one of these metals, and may be a single layer or may have multiple layers.

A semiconductor layer 140 is disposed on a portion of the gate dielectric 130 above the gate electrode 124 to include a portion underneath the source and drain electrodes 165 and 166. In more detail, at least a portion of the semiconductor layer 140 overlaps the gate, source, and drain electrodes 124, 165, and 166. The gate, source, and drain electrodes 124, 165, and 166 function as three electrodes of the first TFT 101. The semiconductor layer 140 between the source and drain electrodes 165 and 166 functions as a channel of the first TFT 101.

In addition, ohmic contacts 155 and 156 may be respectively disposed between the semiconductor layer 140 and the source electrode 165 and between the semiconductor layer 140 and the drain electrode 166 to reduce contact resistances between the semiconductor layer 140 and the source electrode 165 and between the semiconductor layer 140 and the drain electrode 166. The ohmic contacts 155 and 156 may be made of amorphous silicon and may be highly doped with silicide or n-type impurities.

A passivation layer 170, which may be made of a low dielectric constant material such as a-Si:C:O or a-Si:O:F, an inorganic dielectric material such as silicon nitride or silicon oxide, or an organic material, may be disposed on the gate dielectric 130 through plasma enhanced chemical vapor deposition (PECVD) to cover the data metal lines 161a, 161b, 165, and 166.

A color filter 175 having three primary colors is disposed on the passivation layer 170. The colors of the color filter are not limited to the three primary colors and may be variously formed with one or more colors. The color filter 175 provides color to light passing through the display device 900.

In the exemplary embodiment, the color filter 175 is disposed on the passivation layer 170. However, the present disclosure is not limited thereto. For example, the color filter 175 may be disposed between the passivation layer 170 and the data metal lines 161a, 161b, 165, and 166. Alternatively, the color filter 175 may be disposed on the second substrate 200 rather than the first substrate 100.

A light blocking member 176 is disposed on a portion of the passivation layer 170 above the TFT 101. The light blocking member 176 prevents the first TFT 101 from malfunctioning due to light leakage caused by light directed to the channel region of the first TFT 101. The light blocking member 176 may be omitted as needed.

A capping layer 179 is disposed on the color filter 175 and the light blocking member 176. The capping layer 179 protects the organic layers including the color filter 175. However, the capping layer 179 may be omitted as needed. The capping layer 179 may be made of a variety of materials including an inorganic material similar to the protective layer 170.

The protrusion pattern portion 181 and the spacer portion 185 are disposed on the capping layer 179. The protrusion pattern portion 181 and the spacer portion 185 may be made by exposing and developing a photosensitive organic material. However, the present invention is not limited thereto. That is, the protrusion pattern 181 and the spacer portion 185 may be made of a variety of other materials.

The protrusion pattern portion 181 includes protrusions that each may have a semi-circular shape section or a semi-oval shape section. However, the present invention is not limited thereto. The protrusions may have a polygonal section.

The spacer portion 185 is thicker than the protrusion pattern portion 181. The spacer portion 185 is disposed above the first TFT 101 to planarize a region above the first TFT 101.

The spacer portion 185 is disposed on an area greater than an area where the column spacer 285 facing the spacer portion 100 is disposed to prevent the column spacer 285 from being misaligned. Therefore, misalignment between the spacer portion 185 and the column spacer 285 may be prevented when the first and second substrates 100 and 200 are assembled with each other.

The first and second electrodes 191 and 192 are disposed on the protrusion pattern portion 181. When the protrusion pattern portion 181 is disposed underneath only one of the first and second electrodes 191 and 192, the other of the first and second electrodes 191 and 192 is disposed directly on the capping layer 179.

The first electrode 191 is connected to the first TFT 101 and the second electrode 192 is connected to the second TFT 102 (see FIG. 1). The first and second electrodes 191 and 192 may be made of a transparent conductive material, such as indium tin oxide (ITO) and indium zinc oxide (IZO). In more detail, the first electrode 191 includes an electrode portion 1912 and a connecting portion 1911 connecting the electrode portion 1912 to the first TFT 101. A portion 1915 of the first electrode 191 overlaps the storage electrode line 128 to form a storage capacitor.

The passivation layer 170 and the capping layer 179 are provided with a plurality of contact holes 171 and 172 to partly expose the drain electrodes 166. The contact holes 171 and 172 formed in the passivation layer 170 and the capping layer 179 may extend through the color filter 175 as needed. The first and second electrodes 191 and 192 are coupled to the drain electrodes 166 of the first and second TFTs 101 and 102 through the contact holes 171 and 172. The color filter 175 has an opening 174 corresponding to the storage electrode line 128.

The alignment of the blue-phase liquid crystal molecules of the liquid crystal layer 300 varies according to the horizontal electric field induced between the first and second electrodes 191 and 192, controlling light transmittance by the alignment of the blue-phase.

The following will describe a structure of the second substrate 200.

The second substrate 200 includes the second substrate member 210 and the column spacer 285. The second substrate member 210 may be made of a transparent material, such as glass, quartz, ceramic, or plastic.

Particularly, the second substrate member 210 may be made of plastic to reduce the weight and thickness thereof. The plastic may be one of a polycarbonate, a polyimide, a polyethersulfone (PES), a polyarylate (PAR), a polyethylene (PAR), a plyethylenenaphthalate (PEN), and a polyethylene terephthalate (PET). However, the present invention is not limited thereto.

The column spacer 285 faces the spacer portion 185 of the first substrate 100. That is, the column spacer 285 and the spacer portion 185 may contact each other to stably maintain the gap between the first and second substrates 100 and 200.

The column spacer 285 may be made by exposing and developing a photosensitive organic material.

According to the display device 900 of the exemplary embodiment of the present disclosure, a sufficient gap may be secured between the substrates 100 and 200, which may reduce the driving voltage and improve light transmittance.

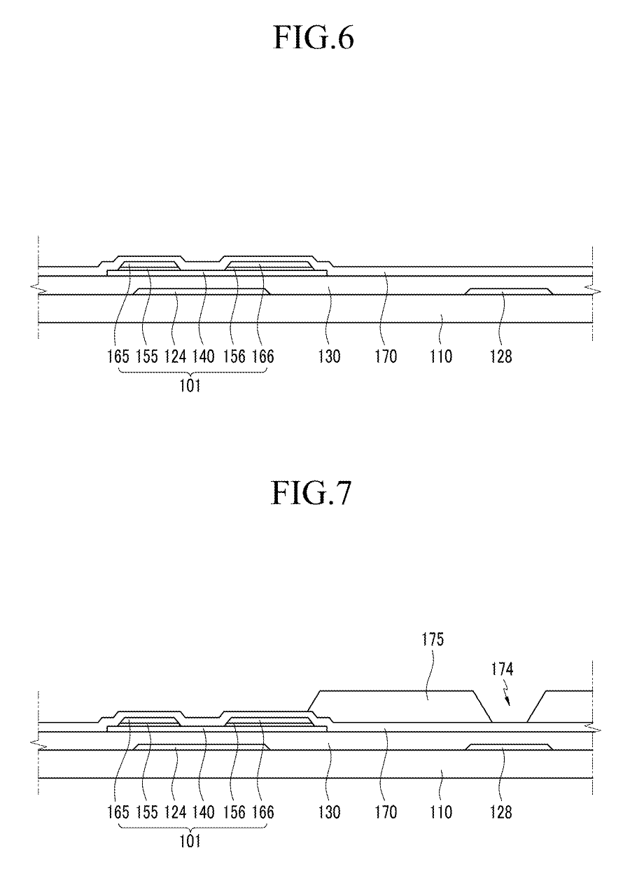

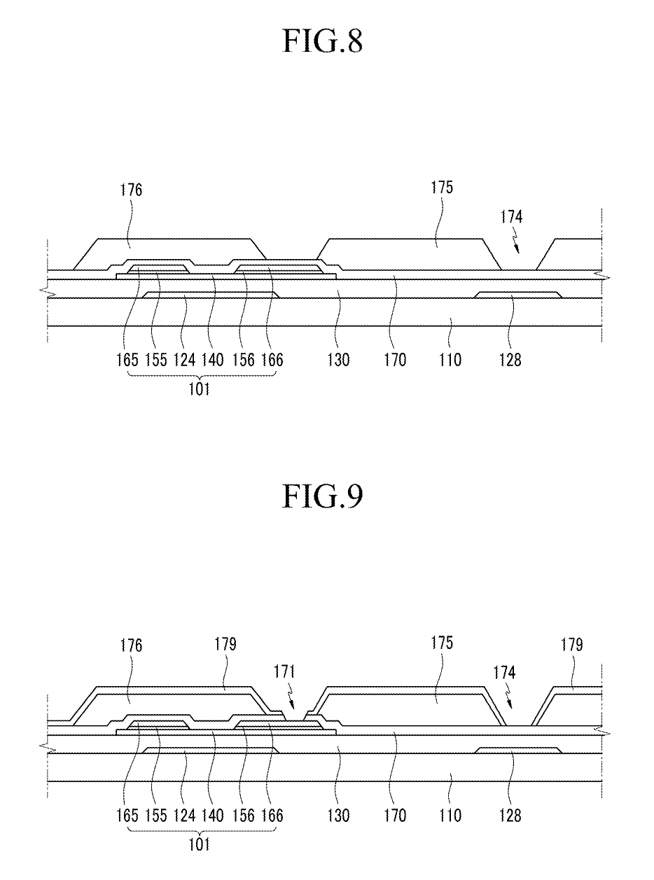

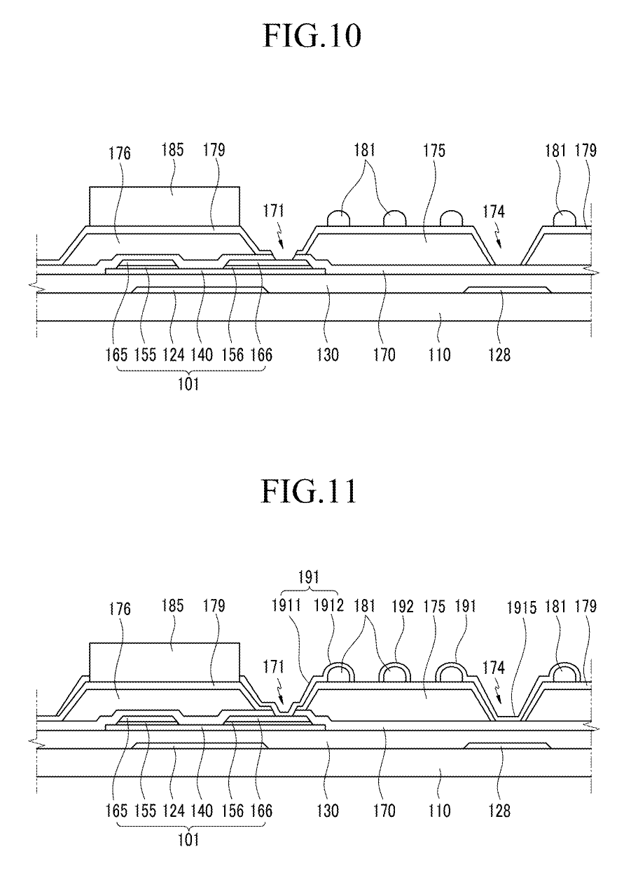

A method of manufacturing the display device 900 according to an exemplary embodiment of the present disclosure will be described with reference to FIG. 6, FIG. 7, FIG. 8, FIG. 9, FIG. 10, and FIG. 11.

As shown in FIG. 6, the TFT 101 including the gate electrode 124, the semiconductor layer 140, the ohmic contacts 155 and 156, and the drain and source electrodes 166 and 165, and the passivation layer 170 covering the TFT 101, are first formed. Here, the structure of the TFT 101 is not limited to the configuration shown in the drawings. The storage electrode line 128 is formed on the same layer as the gate electrode 124 and may be formed of the same material as the gate electrode 124.

Next, as shown in FIG. 7, the color filter 175 is formed on the passivation layer 170. The color filter 175 is provided with the opening 174 corresponding to the storage electrode line 128.

As shown in FIG. 8, the light blocking member 176 is formed to cover the TFT 101.

Next, as shown in FIG. 9, the capping layer 179 is formed to cover the color filter 175 and the light blocking member 176, and the contact holes 171 to expose the drain electrode 166 of the TFT 101 are formed through a photolithography process.

Next, as shown in FIG. 10, the protrusion pattern portion 181 and the spacer portion 185 are formed by applying the photosensitive organic layer on the capping layer 179 and exposing and developing the photosensitive organic layer. The spacer portion 185 is formed to be thicker than the protrusion pattern portion 181. The protrusion pattern portion 181 may have a height of 1-6 μm. The spacer portion 185 planarizes a region above the TFT 101. As described above, the spacer portion 185 may be simultaneously formed with the protrusion pattern portion 181 without using an additional process.

Next, as shown in FIG. 11, the first and second electrodes 191 and 192 are formed on the protrusion pattern portion 181. In FIG. 11, although both the first and second electrodes 191 and 192 are formed on the protrusion pattern portion 181, the present invention is not limited thereto. That is, only one of the first and second electrodes 191 and 192 may be formed on the protrusion pattern portion 181.

The first and second electrodes 191 and 192 are spaced apart from each other and are connected to the first and second TFTs 101 and 102 through the contact holes 171 and 172, respectively. The first and second electrodes 191 and 192 may have slit patterns that are alternately engaged with each other. In addition, the first and second electrodes 191 and 192 may have a width of 1-10 μm, and may be spaced apart from each other by a distance of 3-6 μm.

According to the display device of the exemplary embodiments of the present disclosure, since a sufficient gap between the substrates may be secured, the driving voltage may be reduced, and light transmittance may be improved.

According to the display device manufacturing method of the exemplary embodiment of the present disclosure, since a sufficient gap between the substrates may be secured, the driving voltage of the display device may be reduced, and light transmittance may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a first substrate comprising:
a first electrode and a second electrode spaced apart from each other,
a protrusion pattern portion disposed underneath at least one of the first electrode and the second electrode, and
a spacer portion on the same layer as the protrusion pattern portion and comprising the same material as the protrusion pattern portion;
a second substrate that faces the first substrate and comprises a column spacer facing the spacer portion; and
a liquid crystal layer disposed between the first substrate and the second substrate,
wherein the spacer portion and the column spacer maintain a gap between the first substrate and the second substrate, and
the liquid crystal layer is in an isotropic state when no electric field is applied and is in an anisotropic state when an electric field is applied.

2. The display device of claim 1, wherein the gap maintained by the spacer and the column spacer between the first substrate and the second substrate is 3 μm or more.

3. The display device of claim 2, wherein the spacer portion is thicker than the protrusion pattern portion.

4. The display device of claim 3, wherein the spacer portion has a height of 1.1-10 μm.

5. The display device of claim 3, wherein the protrusion pattern portion has a height of 1-6 μm.

6. The display device of claim 1, wherein the first substrate further comprises a first thin film transistor connected to the first electrode and a second thin film transistor connected to the second electrode, and
the first electrode and the second electrode have slit patterns that are alternately engaged with each other.

7. The display device of claim 6, wherein the spacer portion corresponds to the first thin film transistor and the second thin film transistor, and
the spacer portion planarizes a region above the first thin film transistor and the second thin film transistor.

8. The display device of claim 6, wherein each of the first electrode, the second electrode, and the protrusion pattern portion has a width of 1-10 μm, and
the first electrode and the second electrode are spaced apart from each other by a distance of 3-6 μm.

9. The display device of claim 1, wherein liquid crystal molecules of the liquid crystal layer move according to an electric field induced between the first electrode and the second electrode, and
the electric field is a horizontal electric field that is parallel to the first substrate and the second substrate.

10. The display device of claim 9, wherein the liquid crystal layer includes a cross-linked blue-phase liquid crystal.

11. The display device of claim 1, wherein the protrusion pattern portion and the spacer portion comprise an organic material.

12. A method of manufacturing a display device, comprising:
forming at least one thin film transistor on a substrate member;
forming a photosensitive organic layer on the substrate member and the thin film transistor;
exposing and developing the photosensitive organic layer to form a protrusion pattern portion and a spacer portion; and
disposing a column spacer facing the spacer portion,
wherein the thin film transistor is located between the substrate member and the spacer portion.

13. The method of claim 12, further comprising forming at least one electrode connected to the at least one thin film transistor,
wherein the at least one thin film transistor includes a first thin film transistor and a second thin film transistor,
the at least one electrode includes a first electrode connected to the first thin film transistor and a second electrode connected to the second thin film transistor and spaced apart from the first electrode, and
the protrusion pattern portion is disposed underneath at least one of the first electrode and the second electrode.

14. The method of claim 13, wherein the first electrode and the second electrode have slit patterns that are alternately engaged with each other.

15. The method of claim 14, wherein each of the first electrode, the second electrode, and the protrusion pattern portion has a width of 1-10 μm, and
the first electrode and the second electrodes are spaced apart from each other by a distance of 3-6 μm.

16. The method of claim 12, wherein the spacer portion is thicker than the protrusion pattern portion.

17. The method of claim 12, wherein the spacer portion has a height of 1.1-6 μm.

18. The method of claim 12, wherein the protrusion pattern portion has a height of 1-6 μm.

19. The method of claim 12, wherein the spacer portion planarizes a region above the at least one thin film transistor.

20. The method of claim 12, further comprising forming a color filter between the substrate member and the protrusion pattern portion.
